(19) United States
(12) Patent Application Publication
(10) Pub. No.: US 2026/0080603 A1
(43) Pub. Date: Mar. 19, 2026

(54) DIGITAL ANIMATION GENERATION

(71) Applicant: Adobe Inc., San Jose, CA (US)

(72) Inventors: Mannat Khurana, Hisar (IN); Sanyam Jain, New Delhi (IN); Rishav Agarwal, Panathur (IN)

(73) Assignee: Adobe Inc., San Jose, CA (US)

(21) Appl. No.: 18/887,832

(22) Filed: Sep. 17, 2024

(51) Int. Cl. G06T 13/80; G06T 7/10

(52) U.S. Cl. CPC G06T 13/80; G06T 7/10

(57) ABSTRACT

Digital animation generation techniques are described. In one or more implementations, inputs are received including a description of a digital animation, a digital image, and at least one object. A prompt is formed having text based on the description and animation setting are generated using one or more machine-learning models based on the prompt. A path is calculated based on the digital image and the digital animation is output using the animation settings as animating the at least one object based on the path with respect to the digital image.

### BACKGROUND

Digital animation has been developed to increase a richness, visual appeal, and effectiveness of digital content through inclusion of object motion. Digital animations are configurable using a two-dimensional space as well as a three-dimensional space, such as to incorporate a notion of “Z-order” to control a depth ordering of objects in relation to each other.

Conventional digital animation generation techniques, however, typically involve manual interactions to perform modeling, rigging, animation, rendering, and compositing to produce a digital animation, often utilizing a multitude of frames. Accordingly, conventional digital animation techniques are cumbersome, computationally resource intensive, and rely on specialized user knowledge generally acquired over a significant amount of time. As such, conventional digital animation techniques are not available to casual users that have not gained the specialized user knowledge, do not have access to sufficient resources usable to generate the digital animation, and so forth.

### SUMMARY

Digital animation generation techniques are described that leverage machine learning to generate a digital animation based on an input, e.g., received from a user via a user interface. The input describes a digital animation to be generated, e.g., using text. The inputs, for instance, may include a textual description of the animation as well as a digital image to be used as a basis to form the animation.

The description of the animation is then leveraged by a digital animation system to generate a prompt for processing by one or more machine-learning models, e.g., a large language model (LLM). The prompt, for instance, is structured to provide context about the animation task, input expectations, and a desired output. By embedding specific cues and instructions within the prompt, the one or more machine-learning models are guided to understand animation semantics of a subject upon which the digital animation is to be applied, other entities that may be associated with the digital animation, as well as other animation settings such as preset, duration, transforms, and so forth. These cues are therefore usable to generate animation settings to be used by a digital animation is generating a digital animation that exhibits motion indicated by the description.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

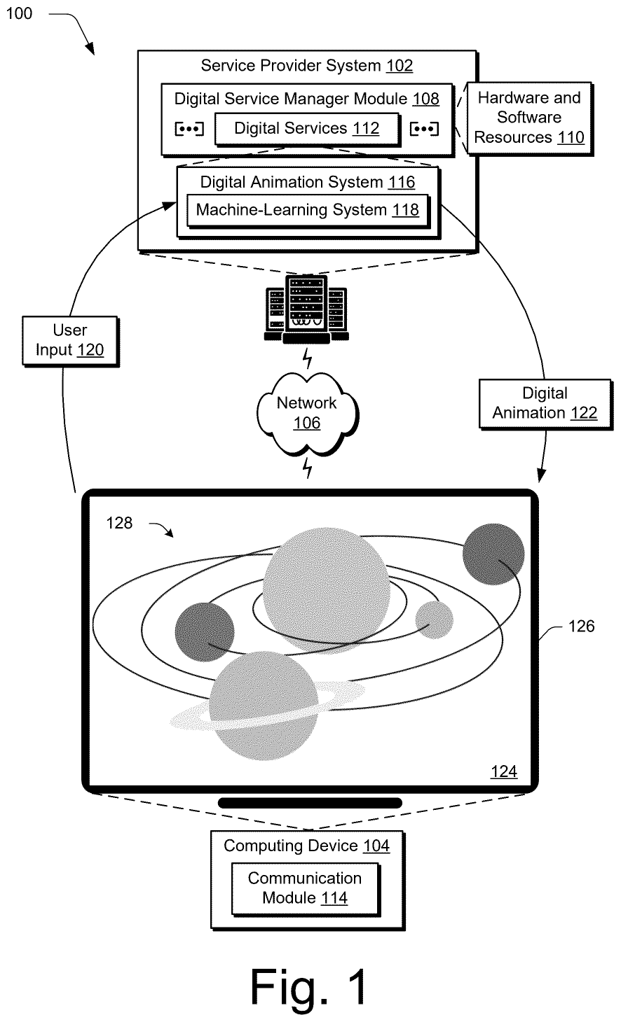

FIG. 1 is an illustration of a digital medium environment in an example implementation that is operable to employ digital animation generation techniques described herein.

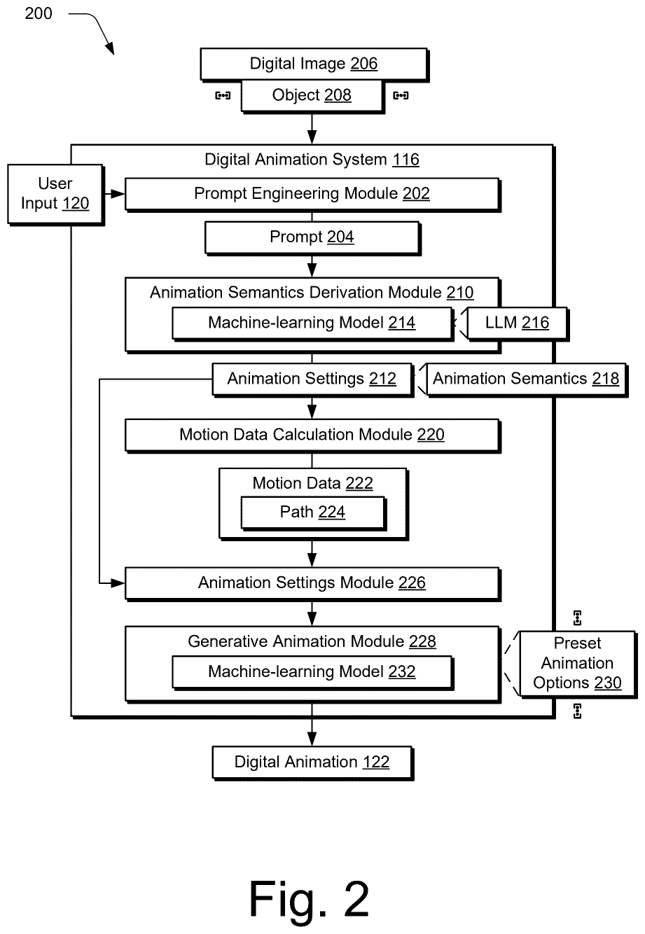

FIG. 2 depicts a system showing operation of a digital animation system of FIG. 1 in greater detail as generating a digital animation based on a user input.

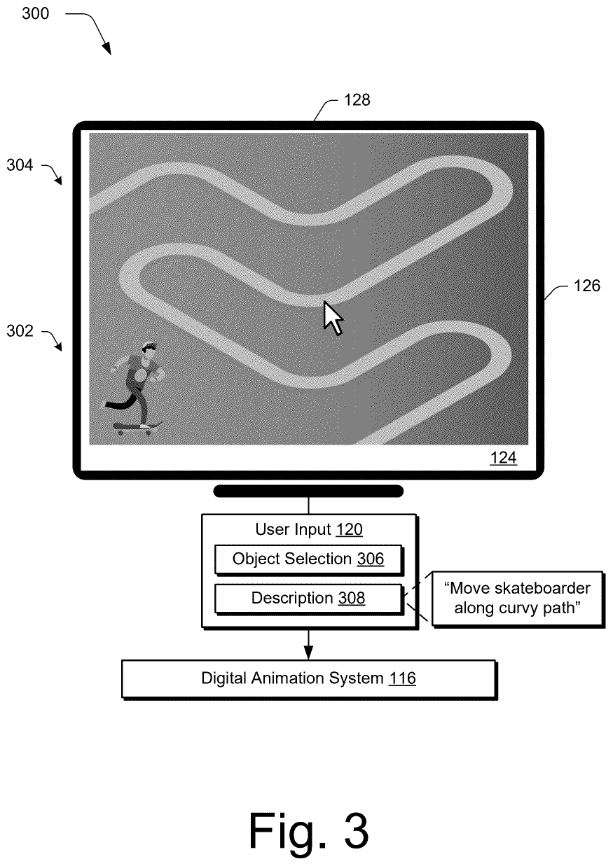

FIG. 3 depicts a system in an example showing receipt of a user input in greater detail as including a description of the digital animation to be generated, a digital image, and at least one object.

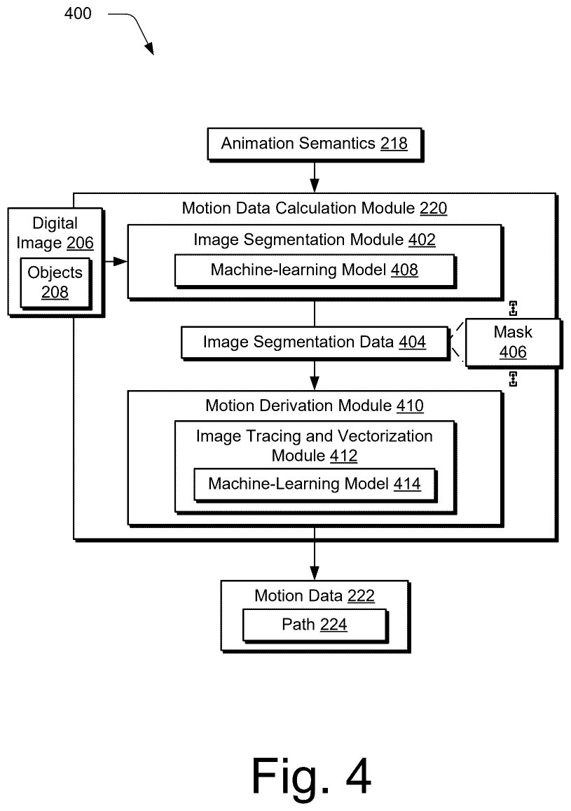

FIG. 4 depicts a system in an example implementation showing operation of a motion data calculation module of FIG. 2 in greater detail as calculating a path.

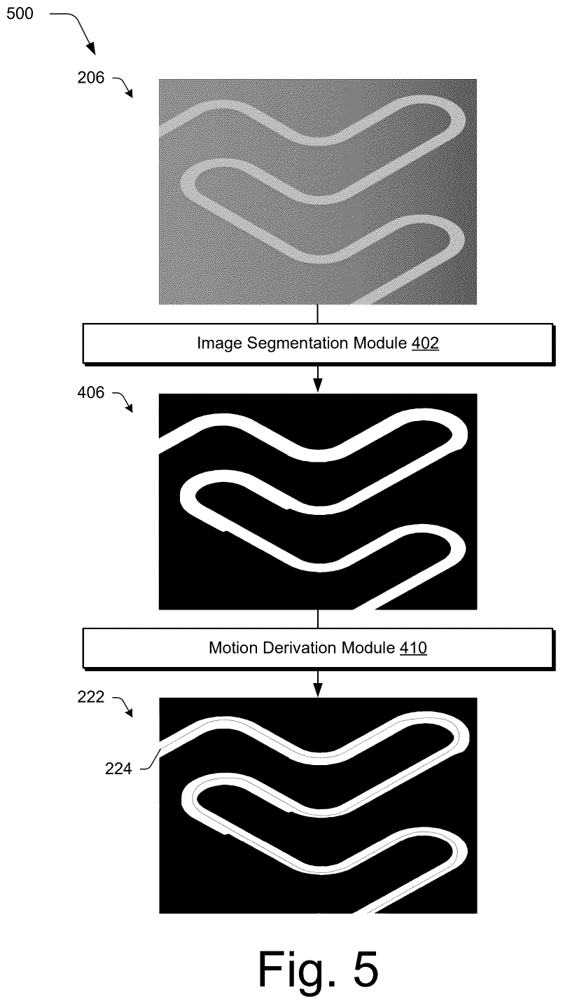

FIG. 5 depicts an example implementation showing operation of a image segmentation module and a motion derivation module of FIG. 4 in greater detail.

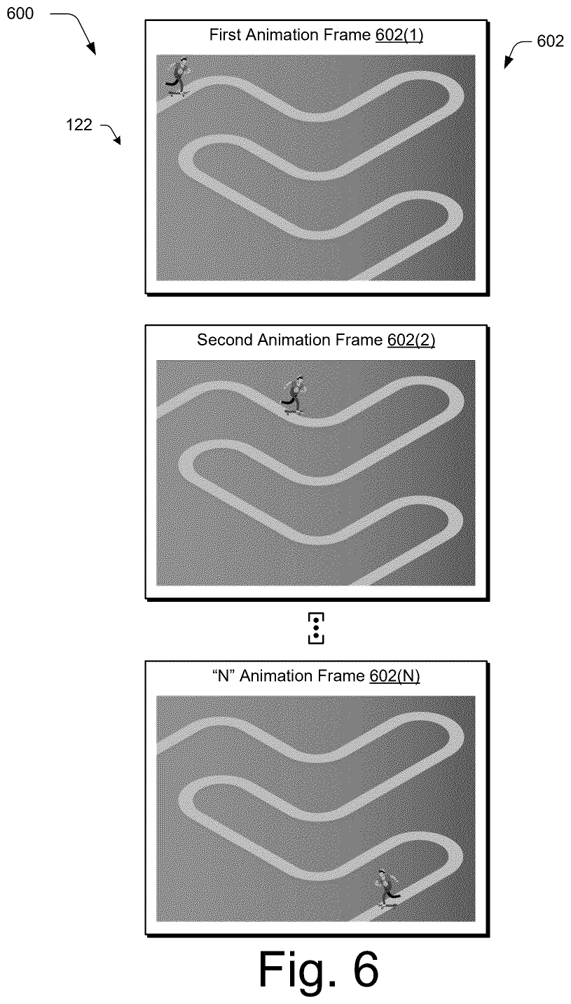

FIG. 6 depicts an example implementation showing output of a digital animation using a plurality of frames.

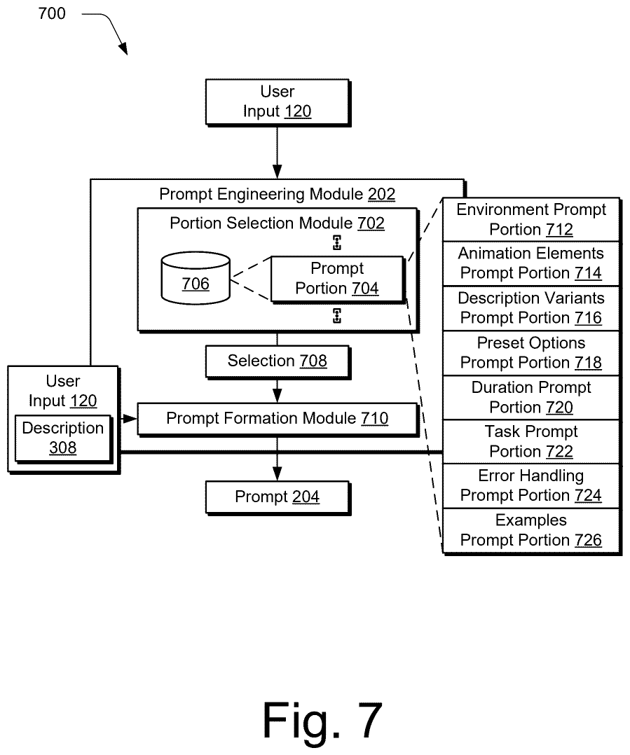

FIG. 7 depicts a system in an example implementation showing operation of a prompt engineering module of FIG. 2 in greater detail as generating a prompt.

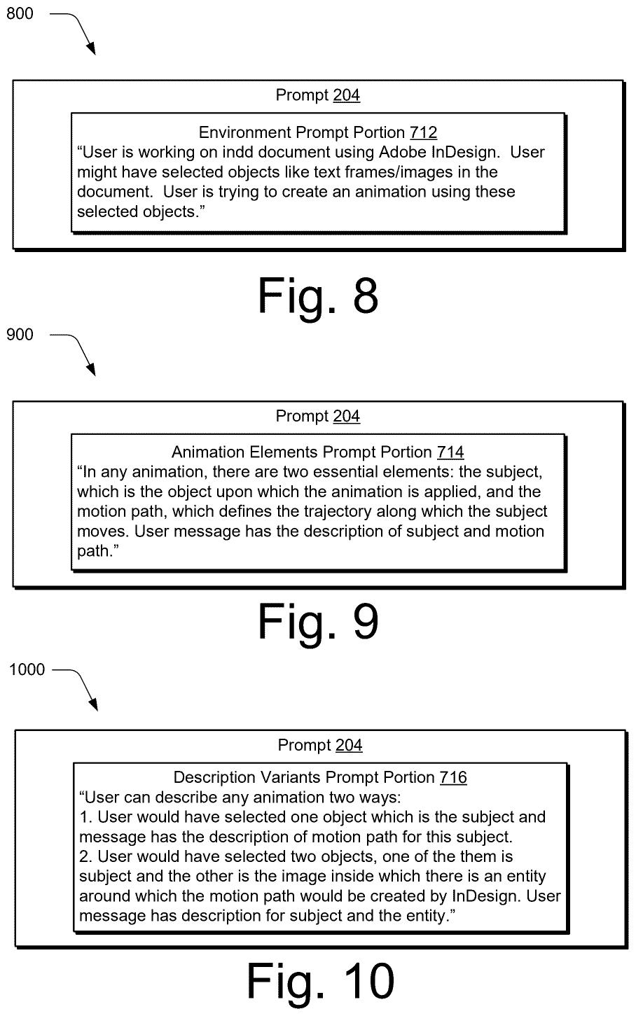

FIG. 8 depicts an example implementation of an environment prompt portion of a prompt.

FIG. 9 depicts an example implementation of an animation elements prompt portion of a prompt.

FIG. 10 depicts an example implementation of a description variants prompt portion of a prompt.

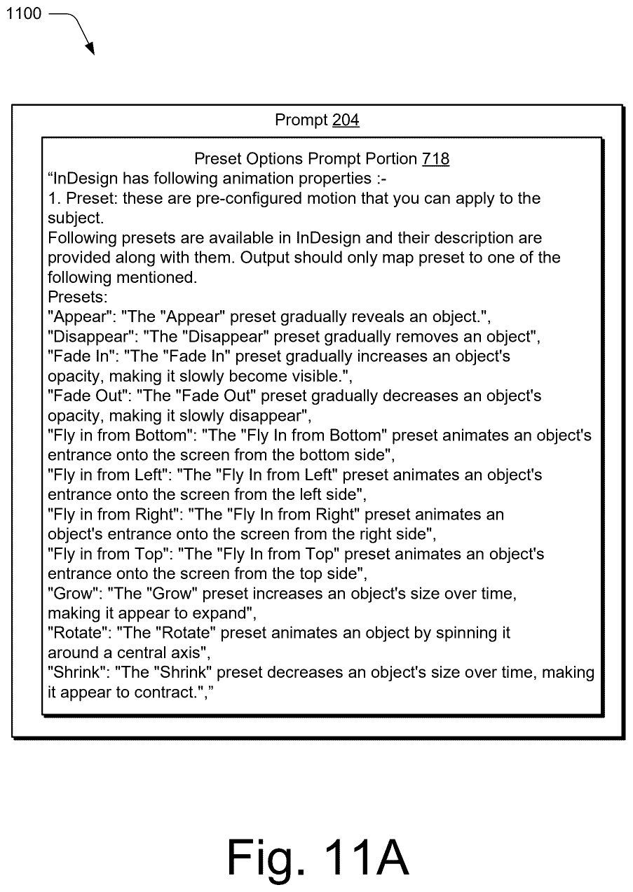

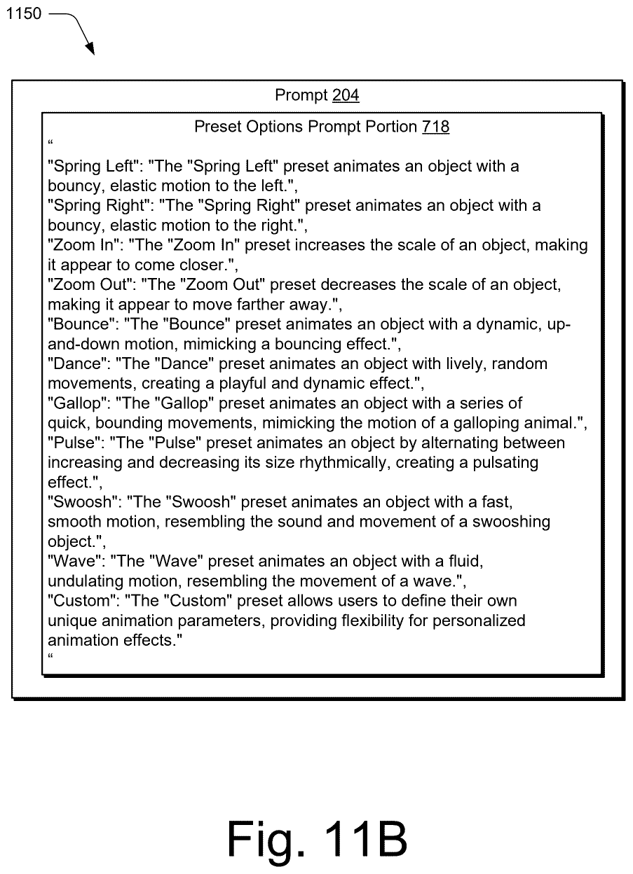

FIGS. 11A and 11B depicts example implementations of a preset options prompt portion of a prompt.

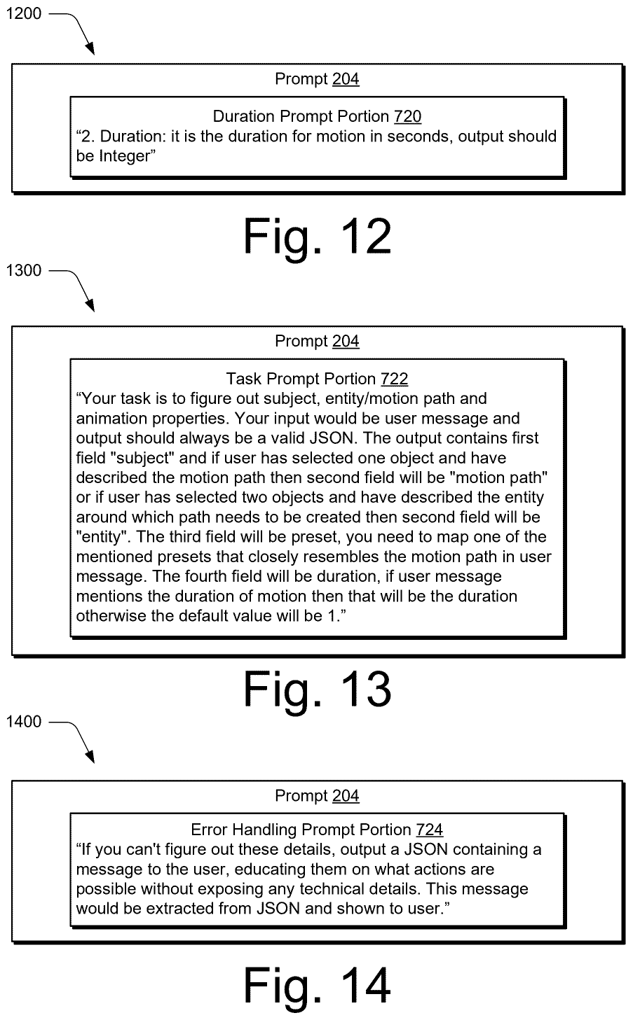

FIG. 12 depicts an example implementation of a duration prompt portion of a prompt.

FIG. 13 depicts an example implementation of a task prompt portion of a prompt.

FIG. 14 depicts an example implementation of a task prompt portion of a prompt.

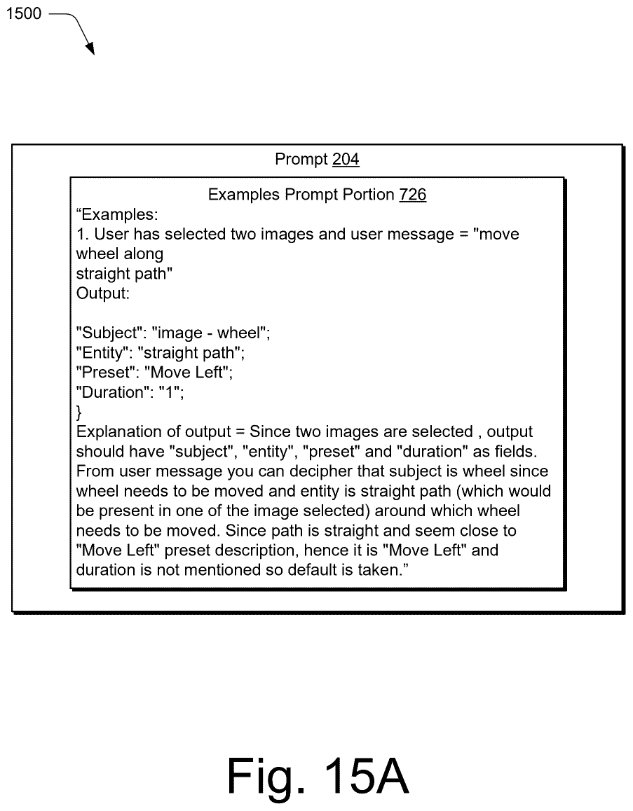

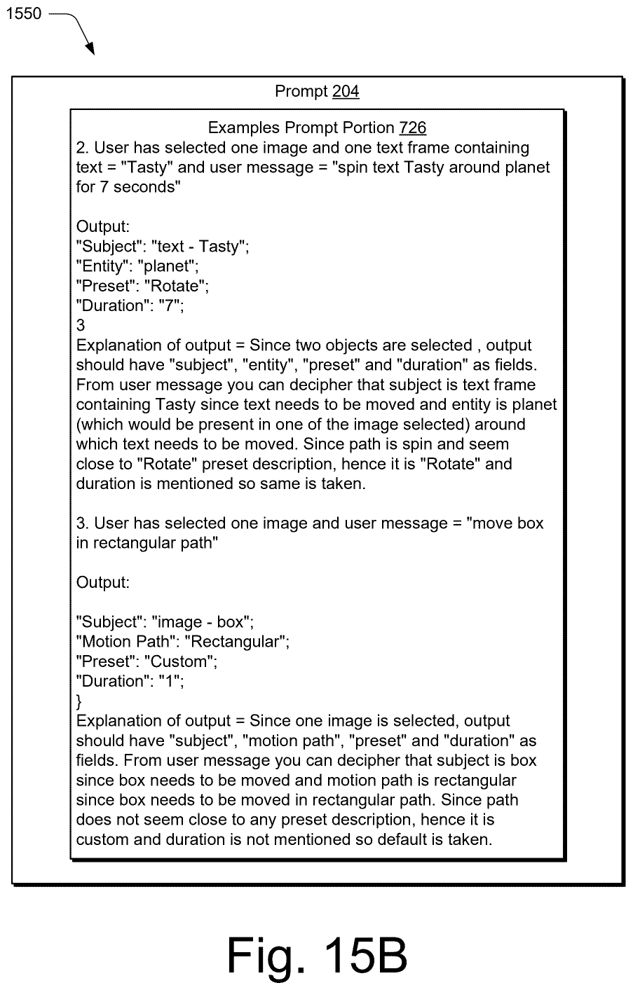

FIGS. 15A and 15B depict example implementations of an examples prompt portion of a prompt.

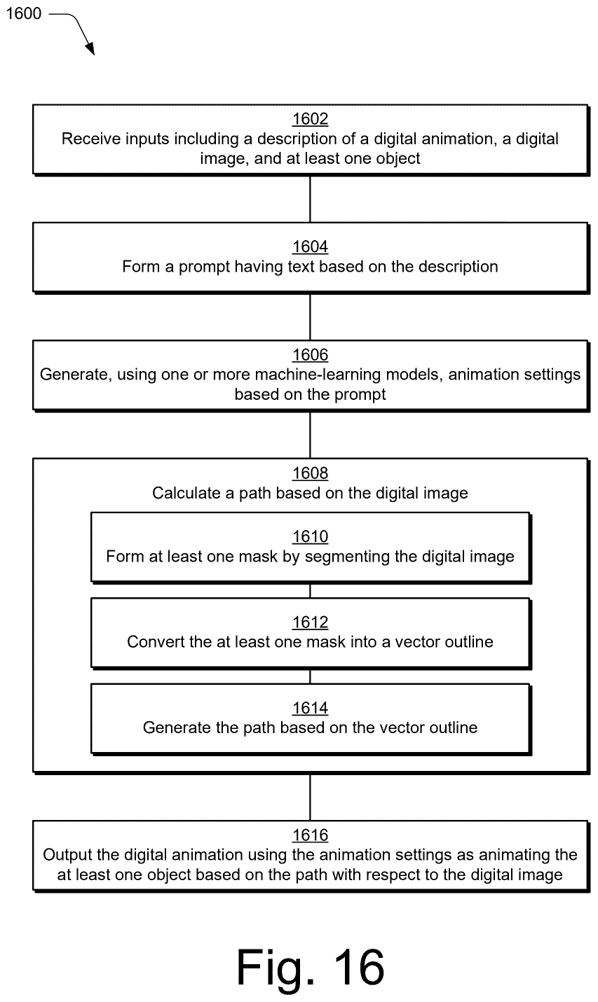

FIG. 16 is a flow diagram depicting an algorithm as a step-by-step procedure in an example implementation of operations performable for accomplishing a result of digital animation generation using machine learning.

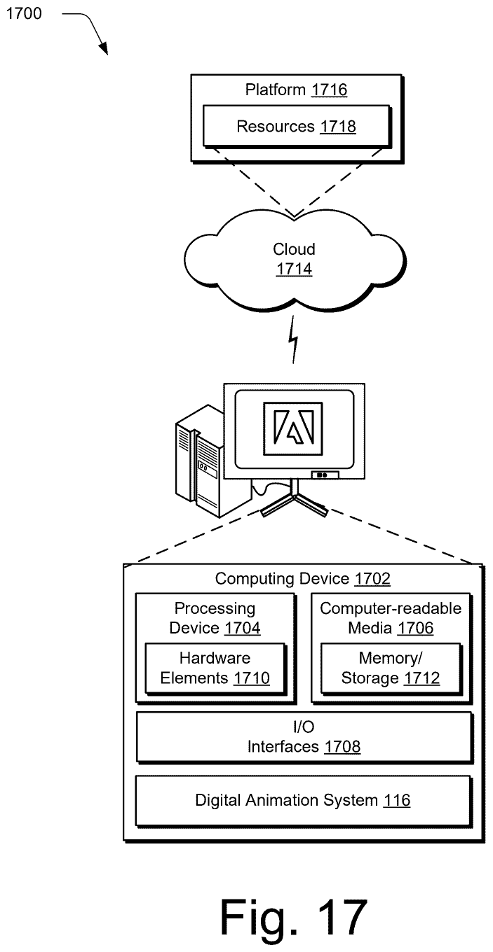

FIG. 17 illustrates an example system including various components of an example device that can be implemented as any type of computing device as described and/or utilize with reference to FIGS. 1-16 to implement embodiments of the techniques described herein.

### DETAILED DESCRIPTION

### Overview

Digital animations, through display of object motion through rendering of a plurality of frames, have been employed to expand a richness of digital content, e.g., webpages, digital documents, video games, presentations, and so forth. A digital animation, for instance, is usable to increase understanding and awareness of relationships of objects to each other that may be difficult to perform solely using text.

Conventional digital animation generation techniques, however, are time consuming, resource intensive, and involve specialized knowledge. In a three-dimensional digital animation example, for instance, conventional techniques used to specify a path for object motion may involve use of a multitude of Bezier curves as well as definition of a Z-ordering of objects in relation to each other.

Consider an example in which a moon is to orbit the Earth in a digital animation. Conventional techniques to do so involve manually drawing an elliptical path as well as defining portions of the path of the moon as either in front of or behind the Earth in this example, which is difficult and time consuming to perform even for those users having specialized knowledge in how to achieve these tasks.

Accordingly, digital animation generation techniques are described that leverage machine learning to generate a digital animation based on an input (e.g., received from a user via a user interface) describing a digital animation to be generated. The inputs, for instance, may include a textual description of the animation such as “orbit the Moon around the Earth” as well as a digital image, which may include one or more objects that are to be used as part of the digital animation, e.g., the Moon.

The description of the animation is then leveraged by a digital animation system to generate a prompt for processing by one or more machine-learning models, e.g., a large language model (LLM). The prompt, for instance, is structured to provide context about the animation task, input expectations, and a desired output.

By embedding specific cues and instructions within the prompt, the one or more machine-learning models are guided to understand animation semantics (i.e., the description) of a subject upon which the digital animation is to be applied (e.g., the Moon), other entities that may be associated with the digital animation (e.g., the Earth), as well as other animation settings such as preset, duration, transforms, and so forth. The prompt is also configurable to specify preset animation options that are available to generate the digital animation, such that, the one or more machine-learning models select one of the preset animation options as well as specify animation settings suitable for the selected model.

The digital animation system is also configured to calculate a path that is to be used to define motion as part of the digital animation. To do so in one or more examples, the digital animation system employs image segmentation to segment objects from a digital image that is to be used as a basis to form the digital animation. After entry of the description, for instance, the digital animation system presents a user interface having the segmented digital image (e.g., using respective masks) and a user input is received selecting one or more objects to be used for the animation based on a respective mask, e.g., the Moon as a subject of the animation. In this way, the digital animation system determines precise locations and boundaries of the entity and/or region of interest.

The digital animation system is also configured to calculate a path used as a basis to define motion in the digital image. To do so, the digital animation system leverages one or more masks as produced above which are then converted to vector outlines. Edge detection and smoothing may also be utilized by the digital animation system to promote accurate following of contours of the object, reduce jagged edges, and produce clean, smooth vector paths. Once the vectors are refined, the path is calculated which may include use of offset paths to enhance clarity and precision through use of parallel paths at a set distance from a primary path.

The animation semantics as generated by the machine-learning model and path are then usable as animation settings to generate a digital animation. The animation settings from the machine-learning model, for instance, may specify a particular type of digital animation model from a plurality of preset animation options and use additional settings such as duration and transforms along with the path to present the digital animation for display in a user interface. In this way, the digital animation generation techniques described herein overcome conventional technical challenges, further discussion of which is included in the following section and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Animation Generation Environment

FIG. 1 is an illustration of a digital medium environment 100 in an example implementation that is operable to employ digital animation generation techniques described herein. The illustrated environment 100 includes a service provider system 102 and a computing device 104 that are communicatively coupled, one to another, via a network 106. Computing devices are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 17.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a digital animation system 116 that employes a machine-learning system 118 (e.g., implemented using one or more machine-learning models) to process a user input 120 to generate a digital animation 122. A user interface 124, for instance, is illustrated as being output by a display device 126 of the computing device 104. The user interface 124 includes a digital image 128 having a plurality of objects, which include depictions of planets and a sun arranged as a solar system.

Conventional digital animation generation techniques, as previously descried, are time consuming, resource intensive, and involve specialized knowledge. In a three-dimensional digital animation example, for instance, conventional techniques used to specify a path for object motion may involve use of a multitude of Bezier curves as well as definition of a Z-ordering of objects in relation to each other. In the illustrated example, for instance, orbits of the planets are configured to pass in front of and behind the sun. Conventional techniques to do so involve manually drawing an elliptical path as well as defining portions of the path of the planets as either in front of or behind the Sun in this example, which is difficult and time consuming to perform even for those users having specialized knowledge in how to achieve these tasks.

In the techniques described herein, however, a user input 120 having a description of “animate the planets to orbit the sun” in text is usable by the digital animation system 116 to generate the digital animation 122 as to exhibit that motion for the respective objects. In one example, the user input 120 also specifies the objects that are to be a subject of the animation, e.g., through selection of corresponding masks segmented from the digital image 128 by the digital animation system 116. In another example, object detection is utilized along with segmentation to identify the object automatically and without user intervention.

The digital animation system 116 is also configured to calculate paths to be employed by respective objects and also employs the machine-learning system 118 to generate animation settings to be used for the digital animation 122 based on the description included in the user input 120. The description, for instance, may be used as a basis by the digital animation system 116 as a structured prompt that is engineered and passed to the machine-learning system 118 to generate the animation settings. The animation settings, which include the path, are then used to present the digital animation 122 for display in the user interface 124, e.g., through output of a series of frames. In this way, the digital animation system 116 addresses the limitations and technical challenges in order to improve accuracy in digital animation 122, reduce computational resource consumption, and improve user interaction efficiency. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Digital Animation Generation

The following discussion describes digital animation generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 16 is a flow diagram depicting an algorithm 1600 as a step-by-step procedure in an example implementation of operations performable for accomplishing a result of digital animation generation using machine learning. In portions of the following discussion reference is made in parallel to the algorithm 1600 of FIG. 16.

FIG. 2 depicts a system 200 showing operation of the digital animation system 116 of FIG. 1 in greater detail as generating a digital animation 122 based on a user input 120. To begin in this example, a prompt engineering module 202 is employed to generate a prompt 204 for processing by the machine-learning system 118 as a way to supply context.

To do so in the illustrated example, inputs are received that include a description of a digital animation via a user input 120, a digital image 206, and at least one object 208 (block 1602). The user input 120, for instance, may be input using text, a spoken utterance converted to text, handwritten, and so forth. The user input 120 is configurable to provide the description of a subject of the digital animation 122 to be generated, describe motion to be associated with the object, and so forth.

FIG. 3 depicts a system 300 in an example showing receipt of the user input 120 in greater detail as including a description of the digital animation 122 to be generated, a digital image 206, and at least one object 208. In this example, a digital image 128 is displayed in a user interface 124. The digital image 128 includes a first object 302 as a skateboarder and a second object 304 as a curvy path.

Since the curvy path is not configured as a basic geometric shape, conventional digital animation generation techniques typically involve use of a pen tool to manually plot points to create to path, convert the path to a motion path, and then manually position the skateboarder at a starting point. Thus, conventional techniques are often tedious, time-consuming, and result in inefficient use of computational resources in support of these manual interactions.

In the illustrated example, the user input 120 is received via the user interface 124 to generate an object selection 306, e.g., to specify the curvy path and the skateboarder. Other automated examples are also contemplated in which object detection is implemented using machine learning to identify the objects, e.g., using a classifier based on a description 308 of the animation to be generated.

In this example, the description 308 is formed using text (e.g., spoken utterance, keyboard, and so forth) and indicates “move skateboarder along curvy path.” Accordingly, the user input 120 supplies both the object selection 306 and the description 308 for processing by the digital animation system 116 to generate the digital animation 122.

Return of the discussion will now be made again to FIG. 2, in which, the prompt engineering module 202 is then configured to form a prompt 204 as having text based on the description 308 (block 1604). As part of generating the prompt 204 in one or more examples, the prompt engineering module 202 is configured to leverage a structure that provides context about the animation task, input expectations, desired form of output, is usable as a basis to select a preset animation option to generate the digital animation 122, and so on. The prompt engineering module 202, for instance, is configurable to select and employ a plurality of prompt portions in support of these functionalities which are then usable to guide generation of animation settings by the machine-learning system 118. Further discussion of prompt 204 formation by the prompt engineering module 202 may be found in relation to FIGS. 7-15.

The prompt 204 is then usable in this example by an animation semantics derivation module 210 to generate animation settings 212 (block 1606). The animation semantics derivation module 210, for instance, implements the machine-learning system 118 of FIG. 1 as one or more machine-learning models 214, an example of which includes an LLM 216. The LLM 216, for instance, is configurable to expand upon and leverage a structured context of the prompt 204 to derive the animation settings 212 as achieving a goal expressed by the description from the user input 120. In this way, the animation semantics derivation module 210 and prompt engineering module 202 of the digital animation system 116 support an ability to interpret intentions and generate meaningful outputs for streamlined generation of the digital animation 122.

As part of generating the animation settings 212, the animation semantics derivation module 210 is also configurable to generate animation semantics 218 (which may be the same as or different from the animation settings 212) that further give context to the description from the user input 120. The animation semantics 218, for instance, are configurable by the LLM 216 to expand upon and/or give alternatives to the description included in the user input 120.

In the illustrated example, the animation semantics 218 are leveraged by a motion data calculation module 220 to calculate motion data 222 specifying a path 224 in this example based on the digital image 206 (block 1608), e.g., for motion that is to be exhibited for the at least one object 208. The motion data calculation module 220 is configurable to calculate the path 224 in a variety of ways.

FIG. 4 depicts a system 400 in an example implementation showing operation of the motion data calculation module 220 of FIG. 2 in greater detail as calculating a path 224. The motion data calculation module 220 is configured to calculate a path 224 (as an example of motion data 222) based on the digital image 206 (block 1608).

To do so, an image segmentation module 402 is configured to form image segmentation data 404 that includes at least one mask 406 formed by segmenting the digital image 206 (block 1610) for respective objects. The image segmentation module 402, for instance, employs a machine-learning model 408 that is trained to predict a segmentation map in which each pixel of the digital image 206 is assigned a class label, which may be further processed by the image segmentation module 402 using conditional random fields (CRFs) to refine segmentation boundaries.

The at least one mask 406 of the image segmentation data 404 is then converted into a vector outline (block 1612) by a motion derivation module 410. The motion derivation module 410, for instance, forms the vector outline using one or more Bezier curves by an image tracing and vectorization module 412, e.g., by tracing edges of the at least one mask 406 to form vectors using a machine-learning model 414. Edge detection and smoothing is then employed by the image tracing and vectorization module 412 to refine the edges of the at least one mask 406, e.g., to ensure that the vectors accurately follow contours of the respective object 208. Smoothing is employed to reduce jaggedness of the edges and produce clean, smooth vectors.

Once the vectors are refined, the path 224 is generated based on the vector outline (block 1614) by the motion derivation module 410. To do so, the motion derivation module 410 begins by forming a primary path that follows an intended shape and movement of the at least one object 208 in relation to the digital image 206. The vectorization module 412 is also configurable to support offset path creation in order to enhance clarity and precision. The offset paths are generated based on the primary path by forming parallel paths at a set distance from the primary path.

In an implementation in which the digital image 206 includes multiple candidate paths, the motion data calculation module 220 is configurable to output the candidate paths in a user interface 124. A user input may then be received to select a particular candidate path, e.g., for further refinement.

FIG. 5 depicts an example implementation 500 showing operation of the image segmentation module 402 and the motion derivation module 410 of FIG. 4 in greater detail. The digital image 206 having the curvy path is received by the image segmentation module 402. Accordingly, the image segmentation module 402 is employed to generate a mask 406. The mask 406, for instance, is identified responsive to a user input received via the user interface 124 to specify the path, e.g., via a “click” received from a cursor control device. In another instance, the path is identified automatically and without user intervention based on the description 308 (e.g., “curvy path”) based on object detection implemented using one or more machine-learning models.

The mask 406 is then processed by the motion derivation module 410 to generate the path 224 as part of the motion data 222. To do so in this example, two vectors are generated based on the mask 406, e.g., as following the contours of the curvy path. A middle point between the two vectors is then chosen as a primary path that is to be converted to the path 224 as previously described. In this way, the path 224 is created automatically and without user intervention by the motion data calculation module 220 to define motion of the digital animation 122 in relation to the digital image 206.

Return will now be made again to FIG. 2, the motion data 222 having the path 224 and the animation settings 212 generated by the animation semantics derivation module 210 using the LLM 216 are then passed as an input to an animation settings module 226. The animation settings module 226 is configured to format the animation settings 212 and the path 224 into a form that is consumable by a respective digital animation model.

A generative animation module 228, for instance, may support a variety of preset animation options 230. Examples of the preset animation options 230 include “appear,” “disappear,” “fade in,” “fade out,” “fly in from bottom,” “fly in from left,” “fly in from right,” “fly in from top,” “grow,” “rotate,” “shrink,” “spring left,” “spring right,” “zoom in,” “zoom out,” “bounce,” “dance,” “gallop,” “pulse,” “swoosh,” “wave,” and “custom,” e.g., which supports personalized animation effects. The prompt 204 is configurable to indicate to the LLM 216 that the preset animation options 230 are available, which is used by the LLM 216 to generate animation settings 212 that select one of the preset animation options 230 and also configure the animation settings 212 for use with the selected option. The animation settings module 226 is then configured to format the path 224 and the animation settings 212 into a manner that is consumable by the selected option. Other examples are also contemplated, including using of generative artificial intelligence implemented using a machine-learning mode 232 to generate the digital animation 122, e.g., to generate code that is executable to implement the digital animation 122.

The digital animation is then output using the animation settings as animating as animating the at least one object based on the path with respect to the digital image (block 1616). FIG. 6 depicts an example implementation 600 showing output of the digital animation 122 using a plurality of frames 602. The plurality of frames includes a first animation frame 602(1), a second animation frame 602(2), through an “N” animation frame 602(N) that depicts a first object of a skateboarder as following a curvy path.

Thus, for this example the description 308 of “move skateboarder along curvy path” as part of a user input 120 is processed by the digital animation system 116. The user input 120 may or may not include an object selection 306. The digital animation system 116 processes the user input 120 to generate the animation settings 212 in an object format consumable by a respective preset animation options 230, e.g., using a JavaScript Object Notation format as follows:

```
{
  “Subject”: “image - skateboarder”;
  “Entity”: “curvy path”;
  “Preset”: “Custom”;
  “Duration”: “1”;
}
```

In this example, the digital animation system 116 determines (e.g., using the LLM 216) that the subject is “skateboarder” because the skateboarder is the object to be moved and the entity is the curvy path, which is present in the digital image 206. Because the curvy path is used to select “custom” from the preset animation options 230 because the curvy path does not directly correspond to other ones of the preset animation options 230.

FIG. 7 depicts a system 700 in an example implementation showing operation of the prompt engineering module 202 of FIG. 2 in greater detail as generating a prompt 204. The prompt engineering module 202 in this example includes a portion selection module 702 that is configurable to select one or more prompt portions 704 from a storage device 706. A selection 708 of the one or more prompt portions 704 are then output to a prompt formation module 710 to form the prompt based on the user input 120, e.g., the description 308 received textually as previously described. Other examples are also contemplated in which including a preconfigured structure prompt, e.g., such that each of the prompt portions 704 are included in the prompt 204 to provide context and guidance.

The one or more prompt portions 704 are configurable in a variety of ways. Illustrated examples of which include an environment prompt portion 712, an animation elements prompt portion 714, a description variants prompt portion 716, a preset options prompt portion 718, a duration prompt portion 720, a task prompt portion 722, an error handling prompt portion 724, and an examples prompt portion 726.

The environment prompt portion 712 is configured to establish an environment, in which, the digital animation is to be output. The animation elements prompt portion 714 is configured to specify that a subject and a path are to be used as part of the digital animation. The description variants prompt portion 716 is configured to describe ways in which the description is usable to describe the digital animation. The preset options prompt portion 718 is configured to reference a plurality of preset animation options that are available for digital animation generation. The duration prompt portion 720 is configured to specify a duration for output of the digital animation. The task prompt portion 722 is configured to specify a task that the one or more machine-learning models is to undertake to discern the subject and the path and an output format of the digital animation. The prompt portion 724 is configured to specify error message generation in response to inaccuracy of the description as including at least one corrective action. The examples prompt portion 726 is configured to include examples of inputs and corresponding animation settings. Each of these examples is described in greater detail below and shown in corresponding figures.

FIG. 8 depicts an example implementation 800 of the environment prompt portion 712 of the prompt 204. The environment prompt portion 712 is configured to establish an operational environment, in which, the digital animation 122 is to be generated. The environment prompt portion 712 also configures the LLM 216 to recognize that a user is engaging in an attempt to create a digital animation.

FIG. 9 depicts an example implementation 900 of the animation elements prompt portion 714 of the prompt 204. The animation elements prompt portion 714 configures the LLM 216 to recognize two components of the digital animation system 116, e.g., a subject and a path of the motion.

FIG. 10 depicts an example implementation 1000 of the description variants prompt portion 716 of the prompt 204. The description variants prompt portion 716 outlines two distinct ways that users may describe the digital animation 122. In the first way, a first object is specified along with a description of motion to be exhibited along a path. In the second way, two objects are specified in which a first is a subject and the second is an entity, around which, the motion is to be specified.

FIGS. 11A and 11B depicts example implementations 1100, 1150 of the preset options prompt portion 718 of the prompt 204. The preset options prompt portion 718 specifies different preset animation options 230 available for implementation of the digital animation 122. Examples of the preset animation options 230 include “appear,” “disappear,” “fade in,” “fade out,” “fly in from bottom,” “fly in from left,” “fly in from right,” “fly in from top,” “grow,” “rotate,” “shrink,” “spring left,” “spring right,” “zoom in,” “zoom out,” “bounce,” “dance,” “gallop,” “pulse,” “swoosh,” “wave,” and “custom,” e.g., which supports personalized animation effects. Accordingly, the preset options prompt portion 718 specifies options, from which, the LLM 216 may select to implement the digital animation 122 based on the description 308 from the user input 120.

FIG. 12 depicts an example implementation 1200 of the duration prompt portion 720 of the prompt 204. The duration prompt portion 720 specifies how a duration for output of the digital animation 122 is to be defined in this example.

FIG. 13 depicts an example implementation 1300 of the task prompt portion 722 of the prompt 204. The task prompt portion 722 clarifies that the task of the LLM 216 is to discern a subject and entity/motion path from the description 308 of the user input 120. The task prompt portion 722 also specifies input parameters to be expected (e.g., the description 308) as well as an output format, e.g., a JavaScript Object Notation (JSON) output structure for respective scenarios.

FIG. 14 depicts an example implementation 1400 of the task prompt portion 722 of the prompt 204. The task prompt portion 722 is configured to stipulate that if the description 308 is inaccurate and/or incompatible, an error message is to be generated. The error message, in one or more examples, also includes corrective actions which may be identified by the LLM 216 based on the error.

FIGS. 15A and 15B depict example implementations 1500, 1550 of the examples prompt portion 726 of the prompt 204. The examples prompt portion 726 is configured to assist clarify of the LLM 216 in understanding for user interaction with the digital animation system 116. Illustrated examples of which include descriptions of the user input 120, an output of animation settings 212, and an explanation of the output.

Thus, digital animation generation techniques are described that leverage machine learning to generate a digital animation based on an input (e.g., received from a user via a user interface) describing a digital animation to be generated. The description of the animation is then leveraged by a digital animation system to generate a prompt for processing by one or more machine-learning models, e.g., a large language model (LLM). The prompt, for instance, is structured to provide context about the animation task, input expectations, and a desired output.

By embedding specific cues and instructions within the prompt, the one or more machine-learning models are guided to understand animation semantics (i.e., the description) of a subject upon which the digital animation is to be applied (e.g., the Moon), other entities that may be associated with the digital animation (e.g., the Earth), as well as other animation settings such as preset, duration, transforms, and so forth. The prompt is also configurable to specify preset animation options that are available to generate the digital animation, such that, the one or more machine-learning models select one of the preset animation options as well as specify animation settings suitable for the selected model as described above.

### Example System and Device

FIG. 17 illustrates an example system generally at 1700 that includes an example computing device 1702 that is representative of one or more computing systems and/or devices that implement the various techniques described herein. This is illustrated through inclusion of the digital animation system 116. The computing device 1702 is configurable, for example, as a server of a service provider, a device associated with a client (e.g., a client device), an on-chip system, and/or any other suitable computing device or computing system.

The example computing device 1702 as illustrated includes a processing device 1704, one or more computer-readable media 1706, and one or more I/O interface 1708 that are communicatively coupled, one to another. Although not shown, the computing device 1702 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1704 is representative of functionality to perform one or more operations using hardware. Accordingly, the processing device 1704 is illustrated as including hardware element 1710 that is configurable as processors, functional blocks, and so forth. This includes implementation in hardware as an application specific integrated circuit or other logic device formed using one or more semiconductors. The hardware elements 1710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1706 is illustrated as including memory/storage 1712 that stores instructions that are executable to cause the processing device 1704 to perform operations. The computer-readable storage medium is configured for storing instructions that, responsive to execution by the processing device, causes the processing device to perform operations. The memory/storage 1712 represents memory/storage capacity associated with one or more computer-readable media. The memory/storage 1712 includes volatile media (such as random access memory (RAM)) and/or nonvolatile media (such as read only memory (ROM), Flash memory, optical disks, magnetic disks, and so forth). The memory/storage 1712 includes fixed media (e.g., RAM, ROM, a fixed hard drive, and so on) as well as removable media (e.g., Flash memory, a removable hard drive, an optical disc, and so forth). The computer-readable media 1706 is configurable in a variety of other ways as further described below.

Input/output interface(s) 1708 are representative of functionality to allow a user to enter commands and information to computing device 1702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1702. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1710 and computer-readable media 1706 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1710. The computing device 1702 is configured to implement particular instructions and/or functions corresponding to the software and/or hardware modules. Accordingly, implementation of a module that is executable by the computing device 1702 as software is achieved at least partially in hardware, e.g., through use of computer-readable storage media and/or hardware elements 1710 of the processing device 1704. The instructions and/or functions are executable/operable by one or more articles of manufacture (for example, one or more computing devices 1702 and/or processing devices 1704) to implement techniques, modules, and examples described herein.

The techniques described herein are supported by various configurations of the computing device 1702 and are not limited to the specific examples of the techniques described herein. This functionality is also implementable all or in part through use of a distributed system, such as over a “cloud” 1714 via a platform 1716 as described below.

The cloud 1714 includes and/or is representative of a platform 1716 for resources 1718. The platform 1716 abstracts underlying functionality of hardware (e.g., servers) and software resources of the cloud 1714. The resources 1718 include applications and/or data that can be utilized while computer processing is executed on servers that are remote from the computing device 1702. Resources 1718 can also include services provided over the Internet and/or through a subscriber network, such as a cellular or Wi-Fi network.

The platform 1716 abstracts resources and functions to connect the computing device 1702 with other computing devices. The platform 1716 also serves to abstract scaling of resources to provide a corresponding level of scale to encountered demand for the resources 1718 that are implemented via the platform 1716. Accordingly, in an interconnected device embodiment, implementation of functionality described herein is distributable throughout the system 1700. For example, the functionality is implementable in part on the computing device 1702 as well as via the platform 1716 that abstracts the functionality of the cloud 1714.

In implementations, the platform 1716 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, inputs including a description of a digital animation, a digital image, and at least one object;
forming, by the processing device, a prompt having text based on the description;
generating, by the processing device using one or more machine-learning models, animation settings based on the prompt;
calculating, by the processing device, a path based on the digital image; and
outputting, by the processing device, the digital animation using the animation settings as animating the at least one object based on the path with respect to the digital image.

2. The method as described in claim 1, wherein:
the description of the digital image identifies the at least one object and specifies motion to be applied to the at least one object; and
the digital image includes the at least one object.

3. The method as described in claim 1, wherein the generating of the animation settings is performed using the one or more machine-learning models configured as a large language model (LLM).

4. The method as described in claim 1, wherein the generating of the animation settings is performed based on the prompt and the path.

5. The method as described in claim 1, wherein the generating of the animation settings includes generating animation semantics of the digital animation using the one or more machine-learning models and wherein the calculating of the path is based at least in part on the animation semantics.

6. The method as described in claim 1, wherein the animation settings select the digital animation from a plurality of preset animation options.

7. The method as described in claim 6, wherein the animations settings specify a subject as the at least one object, an entity corresponding to the path, and a duration for output of the digital animation.

8. The method as described in claim 1, wherein the calculating includes:
forming at least one mask by segmenting the digital image using at least one machine-learning model;
converting the at least one mask into a vector outline; and
generating the path based on the vector outline.

9. The method as described in claim 1, wherein the prompt includes:
an environment prompt portion establishing an environment, in which, the digital animation is to be output;
an animation elements prompt portion specifying that a subject and a path are to be used as part of the digital animation;
a description variants prompt portion describing ways in which the description is usable to describe the digital animation;
a duration prompt portion specifying a duration for output of the digital animation;
a task prompt portion specifying a task that the one or more machine-learning models is to undertake to discern the subject and the path and an output format of the digital animation;
an error handling portion specifying error message generation in response to inaccuracy of the description as including at least one corrective action; and
an examples prompt portion including examples of the inputs and corresponding animation settings.

10. The method as described in claim 1, wherein the prompt includes a preset options prompt portion references a plurality of preset animation options that are available for digital animation generation.

11. The method as described in claim 1, wherein the digital animation specifies a z-order of the at least one object in relation to an additional object such that the path of the at least one object passes before and behind the additional object.

12. A computing device comprising:
a processing device; and
a computer-readable storage medium storing instructions that, responsive to execution by the processing device, causes the processing device to perform operations including:
forming a prompt having text based on a description of a digital animation;
generating, using one or more machine-learning models, animation settings based on the prompt, the animation settings identifying the digital animation from a plurality of preset animation options; and
outputting the digital animation using the animation settings.

13. The computing device as described in claim 12, wherein the animations settings specify a subject as at least one object, an entity corresponding to a path, and a duration for output of the digital animation.

14. The computing device as described in claim 12, further comprising calculating a path based on a digital image and wherein the digital animation is based on the path.

15. The computing device as described in claim 14, wherein the calculating includes:
segmenting the digital image using at least one machine-learning model to form at least one mask;
converting the at least one mask into a vector outline; and
generating the path based on the vector outline.

16. The computing device as described in claim 14, wherein the generating of the animation settings includes generating animation semantics of the digital animation using the one or more machine-learning models and wherein the calculating of the path is based at least in part on the animation semantics.

17. The computing device as described in claim 12, wherein the prompt includes a preset options prompt portion references a plurality of preset animation options that are available for digital animation generation.

18. The computing device as described in claim 12, wherein the prompt includes:
an environment prompt portion establishing an environment, in which, the digital animation is to be output;
an animation elements prompt portion specifying that a subject and a path are to be used as part of the digital animation;
a description variants prompt portion describing ways in which the description is usable to describe the digital animation;
a duration prompt portion specifying a duration for output of the digital animation;
a task prompt portion specifying a task that the one or more machine-learning models is to undertake to discern the subject and the path and an output format of the digital animation;
an error handling portion specifying error message generation in response to inaccuracy of the description as including at least one corrective action; or
an examples prompt portion including examples of inputs and corresponding animation settings.

19. One or more computer-readable storage media storing instructions that, responsive to execution by a processing device, causes the processing device to perform operations including:
receiving inputs including a description of a digital animation, a digital image, and at least one object;
forming a prompt having text based on the description, the prompt providing context about the digital animation, input expectations, and output format;
generating, using one or more machine-learning models, animation settings based on the prompt; and
outputting the digital animation using the animation settings as animating the at least one object with respect to the digital image.

20. The one or more computer-readable storage media as described in claim 19, further comprising calculating a path based on a digital image and wherein the digital animation is based on the path.
